(19) United States
(12) Patent Application Publication
(10) Pub. No.: US 2011/0280550 A1
(43) Pub. Date: Nov. 17, 2011

(54) MOVIE REPRODUCING APPARATUS, MOVIE REPRODUCING METHOD AND RECORDING MEDIUM RECORDING PROGRAM FOR COMPUTER-REALIZATION OF THE MOVIE REPRODUCING APPARATUS

(76) Inventors: Masayuki Shimada, Osaka (JP); Kiyotaka Kashito, Osaka (JP); Takanobu Matsubara, Osaka (JP)

(21) Appl. No.: 13/146,422

(22) PCT Filed: Jan. 26, 2010
(86) PCT No.: PCT/JP2010/050953

§ 371 Date: Jul. 27, 2011

(30) Foreign Application Priority Data
Jan. 28, 2009 (JP) 2009-017020

(51) Int. Cl. H04N 5/00

(52) U.S. Cl. 386/248; 348/E05.001

(57) ABSTRACT

[Object] An object is to continuously reproduce a movie file, even when layout description is changed to improve degree of freedom in expressing provided content.

[Solution]

A UI content processing unit executes a program including: the step (S110) of determining whether or not a movie element is included in received UI content; the step (S150) of continuously displaying a movie that has been reproduced, if the received UI content includes a movie element (YES at S110), a continuous reproduction flag stored in a storage unit is “continuous reproduction on” (YES at S120), the received UI content includes continuous reproduction request information (YES at S130) and the URI of a movie that has been displayed before transition matches the URI of a movie to be displayed after transition (YES at S140); and the step (S180) of displaying a new movie if any of the conditions is unsatisfied (NO at S120, NO at S130 or NO at S140).

[Selected Figure] FIG. 8

### TECHNICAL FIELD

The present invention relates to a movie reproducing technique for reproducing movies by acquiring movie information, layout information and link information through a network and, more specifically, to a movie reproducing technique allowing continuous reproduction of a movie if conditions are satisfied, even if image layout including the movie should be changed.

### BACKGROUND ART

Recently, with the development and diversification of digital transmission technique, use of video-on-demand service, which is a service for distributing arbitrary content as requested by the user, has been increasing, in addition to the conventional one-way broadcasting service such as television broadcast. In relation to the use of such video-on-demand service, conventional approaches include, for example, allocation of link destinations to buttons of a remote controller, to enable transition of screen images to be displayed in accordance with the user's request.

Japanese Patent Laying-Open No. 2008-113385 (Reference 1) discloses a receiver capable of dynamically providing a plurality of link destinations at the time of movie reproduction. The receiver disclosed in Reference 1 includes: a communication unit establishing a link to an external device in response to an operation signal, for receiving movie information and link information; an updating unit repetitively updating the link information received by the communication unit to the latest link information; a composing unit for creating screen image information for displaying the movie information and the latest link information on one screen image; and a control unit for changing, upon reception of an operation signal specifying a certain link destination in the link information, the link destination of the communication unit to the specified link destination. The control unit receives an operation signal corresponding to a numeric key of a remote controller, and specifies one link destination allocated to the numeric key in the link information. The link destination of the control unit is a URL (Uniform Resource Locators) or multi-cast address information.

The receiver obtains the movie and link information related to the movie. In accordance with the link information, information of selectable movies is displayed superimposed on a movie. When a piece of link information is selected, transition is made to a movie indicated by the selected piece of link information.

### SUMMARY OF THE INVENTION

### Problems to be Solved by the Invention

In the receiver disclosed in Reference 1, it is necessary to have the link information embedded in the movie information and, therefore, it is not adapted to allow use of general movie data (the receiver is not generally applicable since it requires embedding link information to the movie data). Further, free updating of link information is impossible during reproduction of a movie, and while a specific movie is being reproduced, only the piece of link information included in the movie is displayed. Further, in the receiver, only the link information is included in the movie information, and it does not allow layout change of screen images.

One example of the movie distribution systems such as described above is acTVila (registered trademark). The system allows such a layout description that a window is opened in a prescribed layout on a certain page, and a movie is reproduced in the window. When the page is switched, however, it follows that the movie that has been played is reproduced anew from the start on the new layout, and continuity of movie reproduction is lost.

Therefore, an object of the present invention is to provide a movie reproducing apparatus receiving and displaying movies, capable of continuously reproducing a movie file even if layout description should be changed to improve degree of freedom in expressing the provided content, as well as to an image forming apparatus including the same, a movie reproducing method, and a recording medium recording a program for realizing computer implementation of the movie reproducing apparatus.

### Means for Solving the Problems

According to a first aspect, the present invention provides a movie reproducing apparatus, including: acquiring means for acquiring data including movie specifying information specifying a movie to be reproduced and continuation request information representing a request for continuously reproducing the movie; display means for displaying images including the movie; user input receiving means for receiving a request for making a display transition input by a user; storage means for storing identification information indicating that continuous reproduction of a movie before and after the transition is requested, based on data acquired before the transition request, and movie information specifying the movie of which continuous reproduction is requested; and control means for continuously reproducing and displaying, when the identification information is stored, the movie specified by the movie specifying information, based on the movie information and data acquired after the transition request. The movie information here is not the information representing the contents of the movie but the information specifying the movie.

The control means may be configured to include: means for storing, if a continuation request information is included in the data acquired before the transition request, the identification information in the storage means and the movie specifying information included in the data acquired before the transition request as the movie information in the storage means; and means for continuously reproducing and displaying the movie specified by the movie specifying information, if the data acquired after the transition request includes the continuation request information, the identification information is stored in the storage means, and the movie specifying information included in the data acquired after the transition request matches the movie information stored in the storage means.

Further, the data may be described in scalable vector graphics language. The movie specifying information and the movie information may be described in link format.

Further, the data may be configured to include layout information defining a manner of reproducing the movie on the display means; and the display means may be configured to include means for displaying images including the movie, in accordance with the layout information.

Further, the data may be configured to include information defining a process when a request for making transition of the display is input; and the control means may be configured to include means for displaying images including the movie after the transition request on the display means in accordance with the information.

The control means may include means for reproducing, if a movie is not to be displayed continuously, the movie specified by the movie specifying information acquired after the transition request, from the start.

According to a second aspect, the present invention provides a movie reproducing method, including: the acquiring step of acquiring data including movie specifying information for specifying a movie to be reproduced and continuation request information representing a request for continuously reproducing the movie; the display step of displaying images including the movie; the user input receiving step of receiving a request for making a display transition input by a user; the storage step of storing identification information representing that continuous reproduction of a movie before and after the transition is requested, and movie information specifying the movie of which continuous reproduction is requested, based on the data acquired before the transition request; and the control step of continuously reproducing and displaying, if the identification information is stored, the movie specified by the movie specifying information, based on the movie information and the data acquired after the transition request.

According to a third aspect, the present invention provides a recording medium recording a computer program causing a computer to function as a movie reproducing apparatus, wherein the computer programs causes, when executed by the computer, the computer to function as: acquiring means for acquiring data including movie specifying information specifying a movie to be reproduced and continuation request information representing a request for continuously reproducing the movie; display means for displaying images including the movie; user input receiving means for receiving a request for making a display transition input by a user; storage means for storing identification information indicating that continuous reproduction of a movie before and after the transition is requested, based on data acquired before the transition request, and movie information specifying the movie of which continuous reproduction is requested; and control means for continuously reproducing and displaying, when the identification information is stored, the movie specified by the movie specifying information, based on the movie information and data acquired after the transition request.

The recording medium mentioned above may include an RAM (Random Access Memory) and an ROM (Read Only Memory) serving as a main memory or an auxiliary memory in a computer, and a hard disk drive (HDD) as an auxiliary memory.

Where a program reading device is provided as a storage device external to a computer, the recording medium may be a recording medium that can be read when loaded on the reading device. Typically, a CPU (Central Processing Unit) reads a computer program from a recording medium other than the main memory, loads the read computer program on the main memory and executes the program. The CPU generally controls various units and components of the computer such that prescribed processes are done in accordance with an installed computer program or programs. Examples of the recording media readable by the program reading device may be any media for recording programs in a fixed manner, including: (1) tapes such as magnetic tapes and cassette tapes; (2) disks such as magnetic disks including flexible disk (FD) and hard disk (HD) or optical disks including CD-ROM (Compact Disc-Read Only Memory), MO (Magneto Optical Disk), MD (Mini Disk) and DVD (Digital Versatile Disk); (3) cards such as IC (Integrated Circuit) cards including a memory card, and optical cards; (4) semiconductor memories such as a mask ROM, EPROM (Erasable Programmable Read Only Memory), EEPROM (Electrically Erasable Programmable Read Only Memory) and a flash memory.

Further, where the computer is made connectable to a communication network including the Internet, the recording medium may be a medium that carries a program in a temporary manner. When a computer program is downloaded from a communication network, the program for downloading may be stored in advance in the computer. Alternatively, the program may be installed from another recording medium.

### Effects of the Invention

By the movie reproducing apparatus, it is possible to continuously reproduce a movie even when display transition is made in response to a user's request. Specifically, text files of XML (eXtensible Markup Language) format using SVG (Scalable Vector Graphics) are interpreted, and a movie is reproduced continuously if all of the following three conditions are satisfied: (A) a piece of identification information is stored in the storage means; (B) continuous reproduction of the movie is requested by the data acquired after the request of transition; and (C) pieces of information specifying movies before and after the transition are the same (the same movie is to be continued). Therefore, it is possible to continuously and safely reproduce a movie without significantly changing an existing browser (the movie can be reproduced safely as the conditions (A) and (B) require the data before and after transition include explicit descriptions in agreement with each other and the data identify one and same movie).

### BRIEF DESCRIPTION OF THE DRAWINGS

FIG. 1 is a block diagram of a movie reproducing system in accordance with an embodiment of the present invention.

FIG. 2 shows a movie sending process where a still image is included in a part of layout.

FIG. 3 shows an exemplary display on the movie reproducing apparatus, illustrating a state before layout switching (screen display (1)).

FIG. 4 shows an exemplary display on the movie reproducing apparatus, illustrating a state after layout switching (screen display (2)).

FIG. 5 shows UI content configuration.

FIG. 6 is a (first) illustration showing details of the UI content corresponding to screen display (1).

FIG. 7 is a (second) illustration showing details of the UI content corresponding to screen display (1).

FIG. 8 is a (third) illustration showing details of the UI content corresponding to screen display (1).

FIG. 9 is a (first) illustration showing details of the UI content corresponding to screen display (2).

FIG. 10 is a (second) illustration showing details of the UI content corresponding to screen display (2).

FIG. 11 is a flowchart representing a control structure of a program executed by a UI content processing unit shown in FIG. 1.

FIG. 12 shows a manner of transition when continuous reproduction of a movie is instructed.

FIG. 13 shows a manner of transition when continuous reproduction of a movie is not instructed.

FIG. 14 shows a manner of transition when continuous reproduction of a movie was instructed but continuous reproduction failed.

### DESCRIPTION OF THE REFERENCE SIGNS

100 movie reproducing system
200 movie reproducing apparatus
210 control unit
220 UI content processing unit
230 movie reproducing unit
240 tuner unit
250 communication unit
260 user input unit
270 display unit
280 storage unit
282 continuous reproduction flag saving area
284 movie URI saving area
300 network
400 movie providing apparatus

### MODES FOR CARRYING OUT THE INVENTION

In the following, an embodiment of the present invention will be described with reference to the figures. In the following description and in the drawings, the same components are denoted by the same reference characters. Their functions and names are also the same. Therefore, detailed description thereof will not be repeated.

<System Configuration>

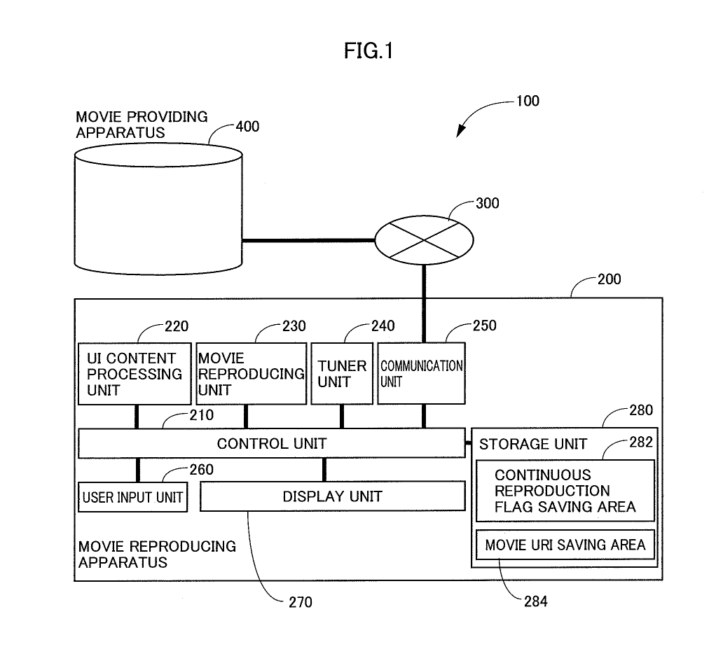

FIG. 1 is a control block diagram of a movie reproducing system in accordance with an embodiment of the present invention. As shown in FIG. 1, a movie reproducing system 100 includes a movie reproducing apparatus 200 and a movie providing apparatus 400. Movie reproducing apparatus 200 and movie providing apparatus 400 are connected to enable communication by a network 300 such as the Internet.

Movie reproducing apparatus 200 reproduces a movie in accordance with descriptions of UI (User Interface or User Interaction) content. UI content and a movie file used in movie reproducing apparatus 200 may both be acquired from movie providing apparatus 400, or may be stored in advance in a storage unit 280 of movie reproducing apparatus 200. Further, the UI content and the movie file may be acquired from different movie providing apparatuses 400. Display position and display size of the movie on movie reproducing apparatus 200 are described in the UI content, and both can be freely designated.

The UI content includes a script description section, a link description section, and a layout description section. The script description section mainly defines a process performed on an occurring event; the link description section defines information of a link destination of the UI content to which transition is to be made next; and the layout description section defines shapes of figures drawn on the screen image, position and size of display of the movie and so on. In the present embodiment, the UI content is a text file of XML format described using SVG.

Movie reproducing apparatus 200 includes a control unit 210, a UI content processing unit 220, a movie reproducing unit 230, a tuner unit 240, a communication unit 250, a user input unit 260, a display unit 270, and a storage unit 280.

UI content processing unit 220 executes a process related to the UI content (SVG file). In this process, UI content processing unit 220 analyzes the contents of script description section in the SVG file, and executes a process in accordance with the result of analysis. By way of example, UI content processing unit 220 analyzes the SVG file and draws the analyzed details on a buffer (not shown) in control unit 210. Alternatively, UI content processing unit 220 analyzes the contents of link description section in the SVG file, instructs communication unit 250 to obtain a file (SVG file, movie file or the like) of the link destination and to store the obtained file in storage unit 280. Further, UI content processing unit 220 refers to the layout description section in the SVG file and instructs display unit 270 to display advertizing information or to display a movie file in a determined layout. The present invention is not limited to such a manner (of acquiring and storing a file first, followed by reproduction), and the present invention is also applicable when data is reproduced while being acquired, such as in the case of streaming.

Movie reproducing unit 230 draws video images obtained by reproducing a movie file that has been acquired from movie providing apparatus 400 through communication unit 250 and stored in storage unit 280, or video images obtained by reproducing a movie file that has originally been stored in storage unit 280, on the buffer of control unit 210. Tuner unit 240 draws video images obtained by decoding received broadcast wave on the buffer of control unit 210. Display unit 270 displays the video images sent from the buffer of control unit 210. The sending process will be described later.

Control unit 210 executes a process based on a user instruction received through user input unit 260. Further, control unit 210 includes the buffer on which UI content processing unit 220 (that mainly draws still images), movie reproducing unit 230 or tuner unit 240 (that mainly draws movies) draws images. Control unit 210 periodically sends the drawn contents of the buffer to display unit 270.

User input unit 260 receives a user operation by, for example, a button operation of a remote controller, and transmits it to control unit 210. Storage unit 280 stores information set by the user, stores a state of a movie continuous reproduction flag in a continuous reproduction flag saving area 282, and stores a URI (Uniform Resource Identifier) of the movie to be continuously reproduced in a movie URI saving area 284. In this manner, the SVG file or the content itself to be reproduced such as a movie file may be stored in storage unit 280 and displayed on display unit 270, or content obtained from communication unit 250 may be stored temporarily on storage unit 280 and then displayed on display unit 270.

Communication unit 250 obtains an SVG file or a movie file through network 300. When a movie that has been stored in storage unit 280 is reproduced as described above, communication unit 250 may not be used for the communication through network 300.

Movie providing apparatus 400 includes: a communication unit for communication with an external device (typically the movie reproducing apparatus 200) through network 300; a storage unit storing UI content, movie data and the like to be transmitted to movie reproducing apparatus 200; and a control unit controlling the communication unit and the storage unit (these storage unit, communication unit and control unit in movie providing apparatus 400 are not shown). Based on requests for acquiring UI content and movie file received from movie reproducing apparatus 200, movie providing apparatus 400 transmits the UI content and the movie file corresponding to the acquisition requests from movie reproducing apparatus 200 from among the pieces of information stored in the storage unit, to movie reproducing apparatus 200 through network 300.

In the present embodiment, storage unit 280 of movie reproducing apparatus 200 stores a program for executing general operations of movie reproducing apparatus 200 of reproducing a movie in accordance with a user request, and a computer program for realizing a UI content process (SVG display process), which will be described later. The computer program may be provided from an external device through network 300. Alternatively, the computer program may be provided by a recording medium such as a DVD, having the computer program recorded thereon. Specifically, a DVD as a medium recording the computer program may be loaded on a DVD drive (not shown) provided inside the movie reproducing apparatus 200, and the program may be read from the DVD and installed to the program storage area in storage unit 280. Control structure of the computer program for realizing the UI content process (SVG display process) will be described later.

<Movie Sending Process>

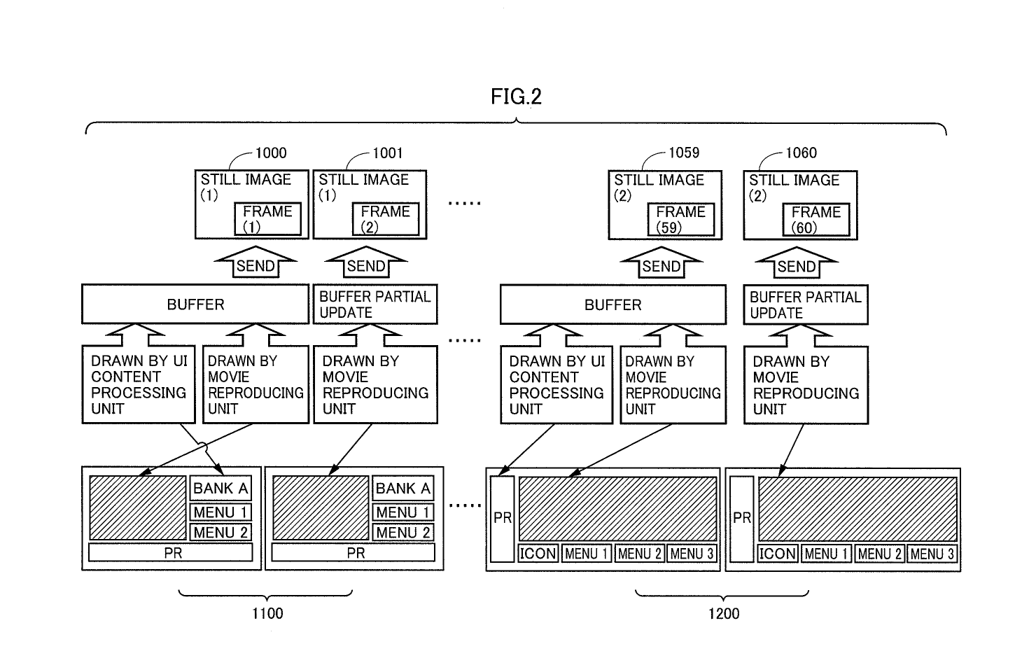

Referring to FIG. 2, the movie sending process where a still image is included in a part of layout will be described. FIG. 2 shows the process where video images sent from the buffer of control unit 210 are displayed on display unit 270. In the example of FIG. 2, it is assumed that the movie includes 60 frames per second. This is based on the method of receiving general broadcast (60 frames/sec) by tuner unit 240. In this method, the video images received by tuner unit 240 are once decoded and drawn using the buffer, and the video images thus stored in the buffer are successively sent to display unit 270.

In accordance with this method, in movie reproducing apparatus 200 of the present embodiment, a still image or images and a movie are displayed in set layout, and even if the layout or still image should be changed, the movie is reproduced continuously as long as predetermined conditions are satisfied.

As shown in FIG. 2, a screen image 1000 consisting of a movie frame (1) and a still image (1), a screen image 1001 consisting of a movie frame (2) after the lapse of 1/60 second from screen image 1000 and still image (1), . . . , a screen image 1059 consisting of a movie frame (59) after the lapse of 59/60 seconds from screen image 1000 and still image (1), and a screen image 1060 consisting of a movie frame (60) after the lapse of 60/60 seconds (that is, 1 second) from screen image 1000 and still image (1), are successively displayed on display unit 270. It is noted that a layout changing process takes place at the 59th/60 of this one second. As the layout changing process, the layout and still images are changed. It is noted, however, that such an update takes place when an explicit instruction such as a transition to the next content is detected. Until then, the displayed contents are maintained continuously and, therefore, the layout including the still images is maintained.

Referring to FIG. 2, the still image portion is drawn by UI content processing unit 220 on the buffer of control unit 210, and on the buffer of control unit 210, still image (1) or still image (2) is drawn. Since the layout changing process has been done at the 59th/60 second as described above, it is the still image (2) of screen image 1059 which the UI content processing unit 220 draws on the buffer.

The movie portion is drawn by movie reproducing unit 230 on the buffer of control unit 210, and movie frames (1) to (60) are drawn in one second on the buffer of control unit 210. In this manner, the area of still image portion is drawn by UI content processing unit 220 and the area of movie portion is drawn by movie reproducing unit 230, respectively, on the buffer, and the composed results are sent by control unit 210 to display unit 270 where the display is given. At the time of movie reproduction, only the area of movie portion (part of the buffer) is updated, while the whole buffer is sent to the display unit 270 (or only the updated portion may be sent to display unit 270).

<Exemplary Displays>

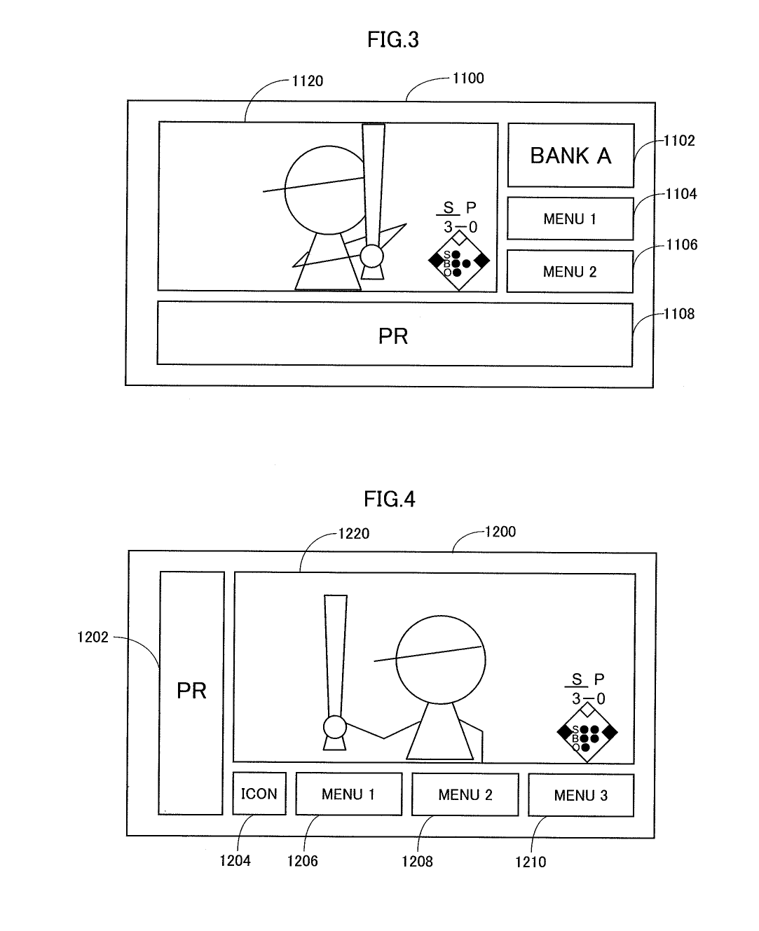

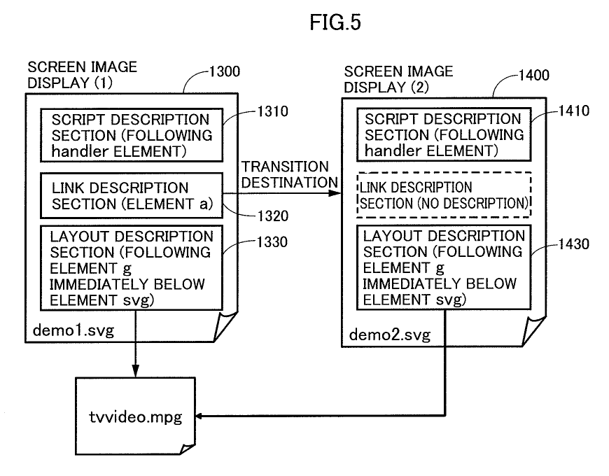

FIGS. 3 and 4 show exemplary displays of video images sent from the buffer of control unit 210 and displayed on display unit 270. FIG. 3 shows a screen image 1100 that corresponds to the screen images 1000 and 1001 of FIG. 2, and FIG. 4 shows a screen image 1200 corresponding to screen images 1059 and 1060 of FIG. 2.

Screen image 1100 shown in FIG. 3 includes still images (1) consisting of an advertising area 1102 presenting an advertisement of BANK A, a display area 1104 of “menu 1”, a display area 1106 of “menu 2” and a display area 1108 of advertisement “PR.” In addition to these still images, screen image 1100 includes a movie area 1120.

Screen image 1200 shown in FIG. 4 includes still images consisting of an advertising area 1202 of advertisement “PR,” a display area 1204 of an “icon”, a display area 1206 of “menu 1”, a display area 1208 of “menu 2” and a display area 1210 of “menu 3.” In addition to these still images, screen image 1200 includes a movie area 1220.

As can be seen from the pictures, what is displayed in movie area 1120 of FIG. 3 and what is displayed in movie area 1220 are continuous movie of a common subject (specifically, the displayed movie is a live baseball game, with the strike count increased by one in one second).

<UI Content Configuration>

FIG. 5 shows a schematic configuration of UI content used for realizing such displays. By way of example, FIG. 5 shows a demo1.svg file 1300 corresponding to the screen image display (1) before transition (corresponding to screen image 1100) and a demo2.svg file 1400 corresponding to a screen image display (2) after transition (corresponding to screen image 1200). These SVG files basically have the same configuration. In the absence of any destination to make a transition next, the file will not have the link description section, as in the case of demo2.svg file 1400 shown in FIG. 5.

The demo1.svg file 1300 consists of a script description section 1310, a link description section 1320 and a layout description section 1330. The demo2.svg file 1400 consists of a script description section 1410 and a layout description section 1430. Further, the ID information (forming a part of URI) for identifying the movie reproduced from these UI contents is “http://video-server.com/tvvideo.mpg.”

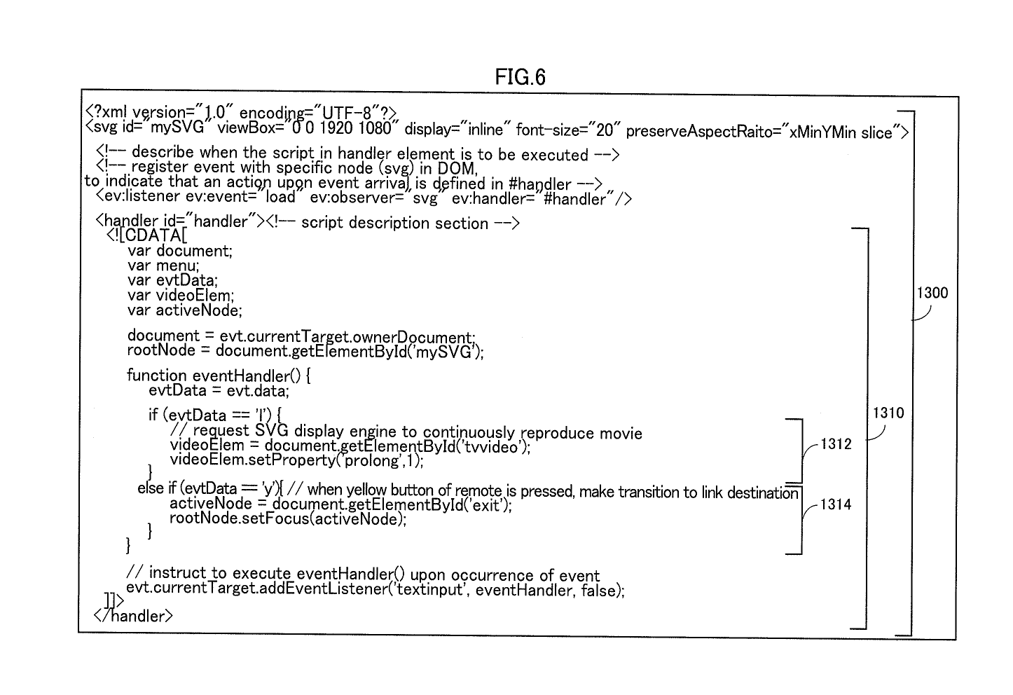

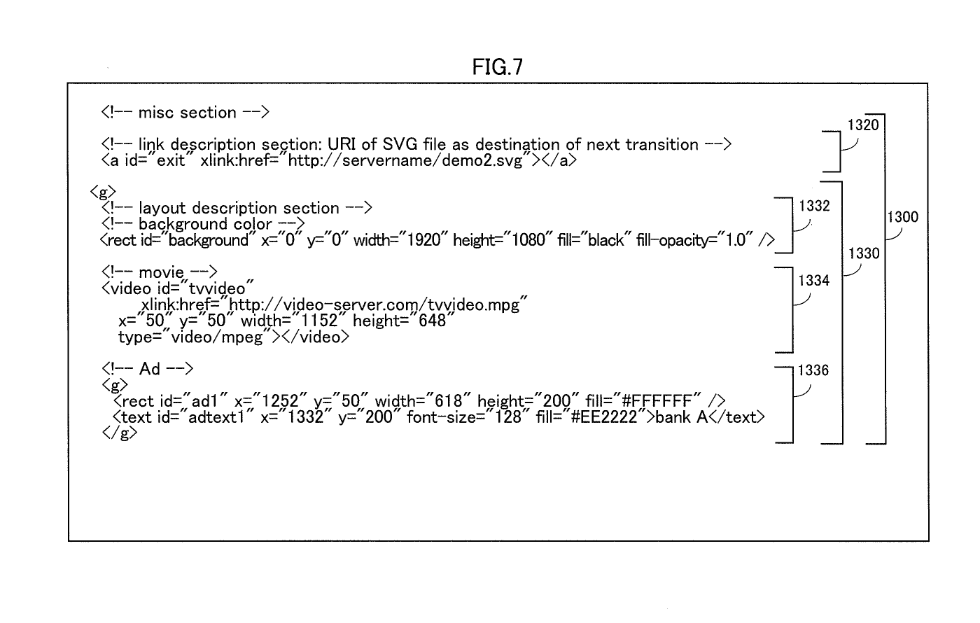

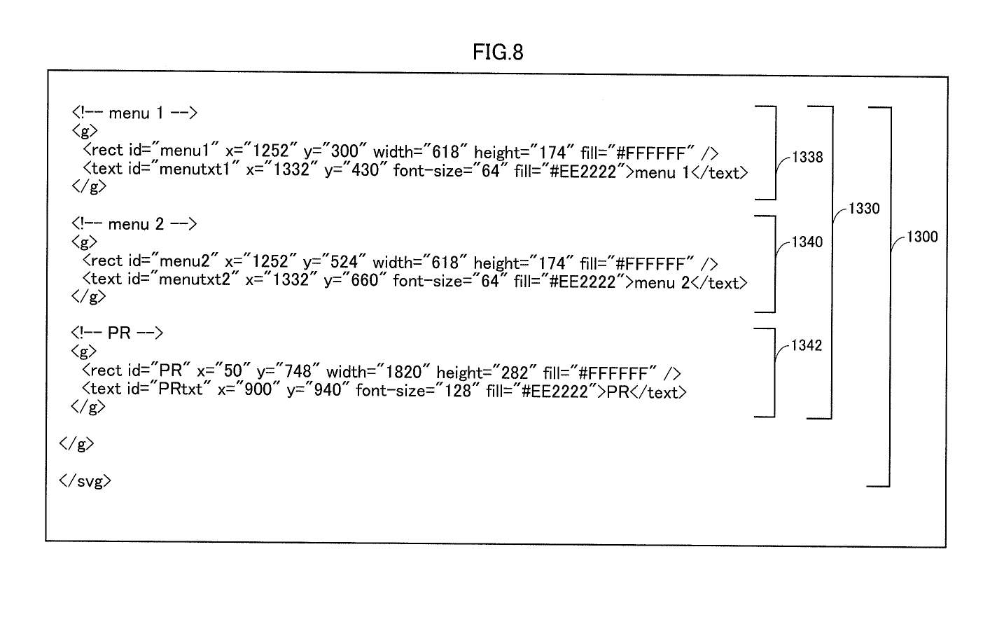

FIGS. 6 to 8 show details of demo1.svg file 1300 as the UI content. As can be seen from FIGS. 6 to 8, demo1.svg file 1300 consists of script description section 1310, link description section 1320 and layout description section 1330.

Script description section 1310 includes a movie continuous reproduction request statement 1312 and a transition request statement 1314. Movie continuous reproduction request statement 1312 defines a statement for turning on a continuous reproduction flag (videoElem.setProperty (‘prolong’,1)). With this definition of the statement, a continuous reproduction flag stored in continuous reproduction flag storage area 282 of storage unit 280 is turned to “continuous reproduction on” by a program as will be described later and, in addition, the attribute value of xlink:href (http://video-server.com/tvvideo.mpg) of a video element having the ID information “tvvideo” designated by the statement mentioned above is saved in a movie URI saving area 284 of storage unit 280.

Transition request statement 1314 defines a process when a user instruction is given by his/her pressing a yellow button, to user input unit 260. If the user instruction is given by pressing the yellow button, an event is notified from control unit 210 to UI content processing unit 220. Transition request statement 1314 defines a process that UI content processing unit 220 receiving the event moves to the next transition destination (link destination) and finishes the display process of demo1.svg.

Link description section 1320 defines a URI (http://servername/demo2.svg) of the next transition destination after the display process of demo1.svg is finished.

Layout description section 1330 includes: a background color designation 1332 defining the background color; a movie designation 1334 defining the contents, display position and size of a movie; an advertisement designation defining the display position, size and contents of the advertisement area presenting advertisement of BANK A; a menu designation 1338 defining the display position, size and contents of the display area for “menu 1”; a menu designation 1340 defining the display position, size and contents of the display area for “menu 2”; and a display designation 1342 defining the display position, size and contents of the display area for the advertisement “PR.”

For executing demo1.svg file 1300, an SVG engine is initialized and the contents of SVG file are analyzed. From the analysis, it can be found that movie designation 1334 is described and, hence, a process for confirming continuous reproduction of a movie takes place. As will be described in detail later with reference to a flowchart, the process when a movie is to be reproduced is as follows.

Since there is no indication of a preceding SVG file and the state of continuous reproduction flag is the initial value of “continuous reproduction off,” a new movie is reproduced. Thereafter, other drawing elements (still images) defined in the SVG file are drawn, the screen image is displayed, and the control enters an event loop. In a terminating process, since the continuous reproduction flag saved in storage unit 280 is “continuous reproduction on,” reproduction of the movie is continued. The terminating process of SVG display engine takes place and, thereafter demo2.svg is acquired successively and displayed.

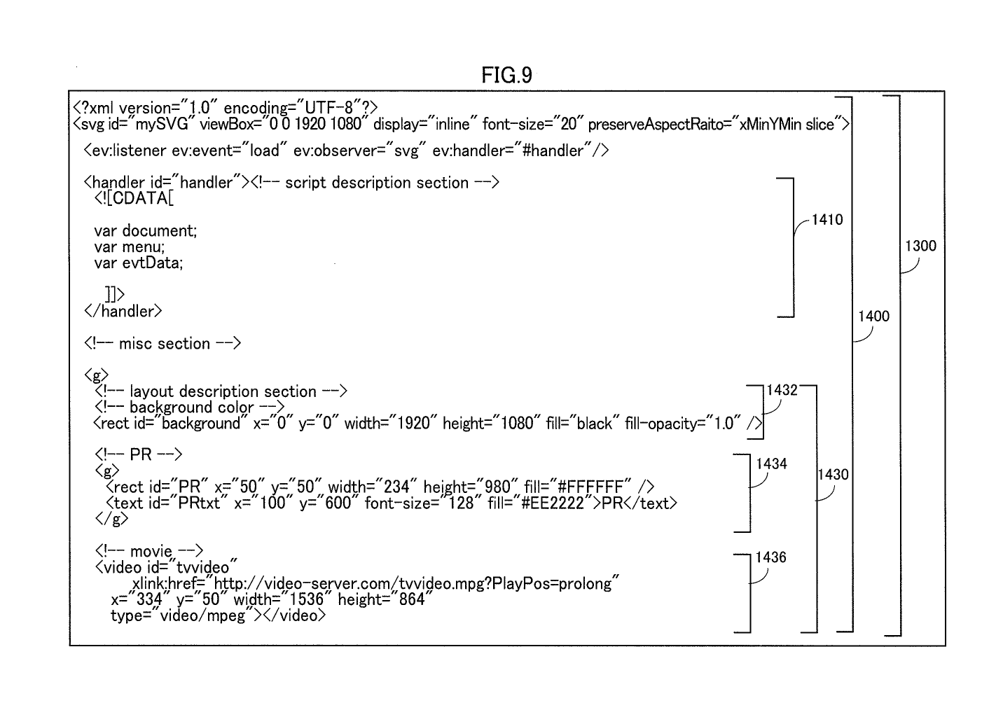

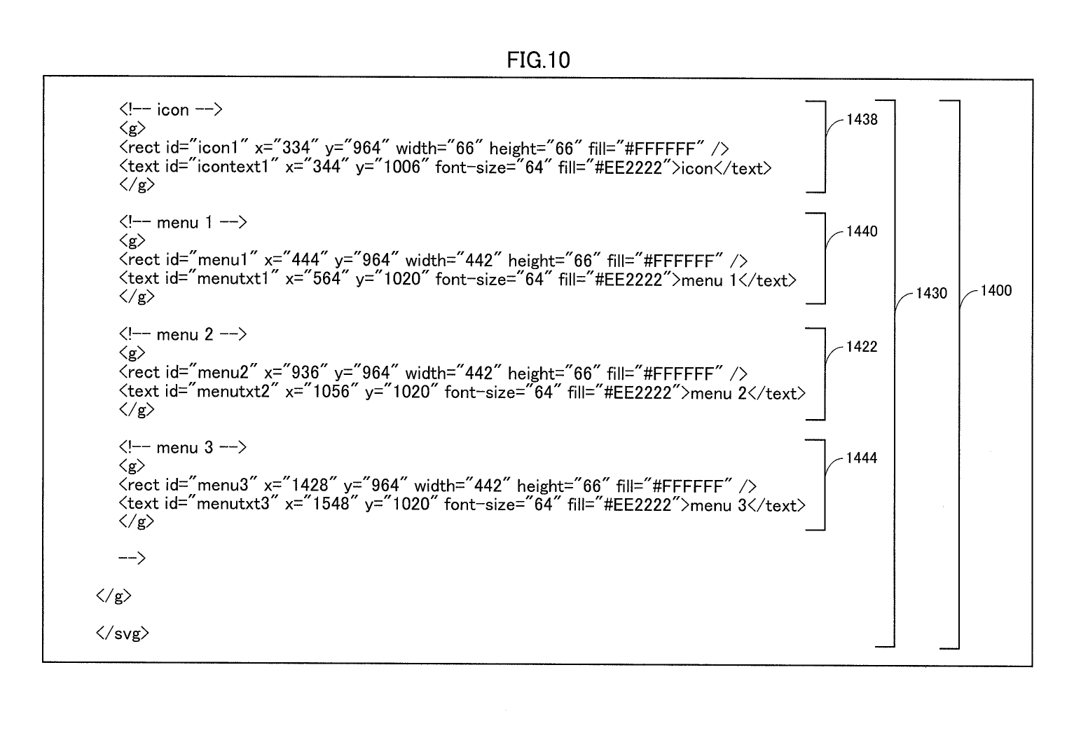

FIGS. 9 and 10 show details of demo2.svg file 1400 as the UI content. As can be seen from FIGS. 9 and 10, demo2.svg file 1400 consists of a script description section 1410 and layout description section 1430.

Layout description section 1430 includes: a background color designation 1432 defining the background color; a display designation 1434 defining the display position, size and contents of the display area for the advertisement “PR”; a movie designation 1436 defining the contents, display position and size of the movie; an icon designation 1438 defining the display position, size and contents of “icon”; a menu designation 1440 defining the display position, size and contents of the display area for “menu 1”; a menu designation 1442 defining the display position, size and contents of the display area for “menu 2”; and a menu designation 1444 defining the display position, size and contents of the display area for “menu 3.”

For executing demo2.svg file 1400, the SVG engine is initialized, and the contents of SVG file are analyzed. From the analysis, it can be found that movie designation 1436 is described and, hence, a process for confirming continuous reproduction of a movie takes place. As will be described in detail later with reference to a flowchart, the process when a movie is to be continuously reproduced is as follows.

The state of continuous reproduction flag stored in continuous reproduction flag saving area 282 of storage unit 280 is “continuous reproduction on” (condition A), a designation “PlayPos=prolong” is included as the attribute value of xlink:href of video element of movie designation 1436 as the identification information (condition B), and the URI of the movie (http://video-server.com/tvvideo.mpg) saved in movie URI saving area 284 of storage unit 280 as the movie information (information for specifying the movie) matches the attribute value of xlink:href of video element of demo2.svg as the movie specifying information with “PlayPos=prolong” removed (condition C). Therefore, the movie that has been reproduced from demo1.svg is continuously displayed. Since a statement for turning on the state of continuous reproduction flag is not included in the video element, the current state of continuous reproduction flag of “continuous reproduction off” is saved in continuous reproduction flag saving area 282 of storage unit 280. Other still images described in the SVG are drawn, the drawn images are displayed on display unit 270, and the control enters an event loop.

<Program Structure>

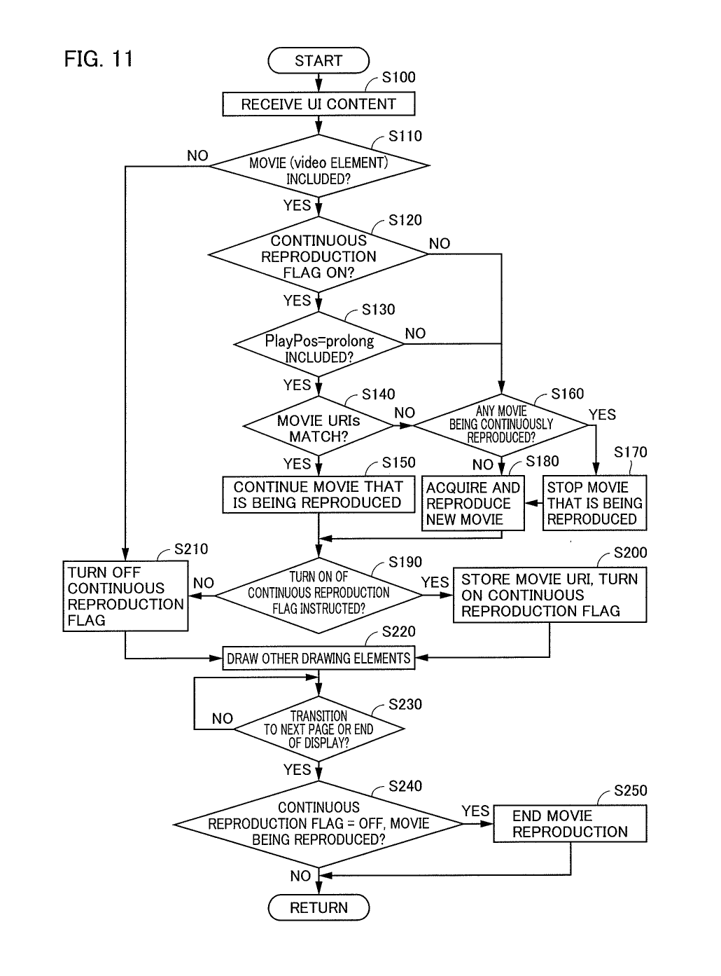

FIG. 11 is a flowchart representing a control structure of a program executed at UI content processing unit 220 of movie reproducing apparatus 200 in accordance with the present embodiment. With reference to the flowchart, the program executed by UI content processing unit 220 will be described. The program is one of the programs executed by UI content processing unit 220, and it also represents a process of the SVG display engine. In the present invention, execution by UI content processing unit 220 is not limiting, and the program may be executed by control unit 210 of movie reproducing apparatus 200.

When the continuous reproduction process takes place, a process for displaying the SVG file before transition and the SVG file after transition is performed, and two movies are displayed (the same movie may be reproduced continuously, or different movies may be reproduced). When the SVG display engine is activated for the first time, the value of continuous reproduction flag is “continuous reproduction off.” In continuous reproduction flag saving area 282, one continuous reproduction flag is stored for one movie URI. In the present example, there is only one movie and, therefore, only one continuous reproduction flag is stored. Similarly, only one URI is stored in movie URI saving area 284.

At step (hereinafter “step” will be denoted by “S”) 100, UI content processing unit 220 receives UI content from movie providing apparatus 400 through network 300, communication unit 250 and control unit 210. The UI content is the SVG file shown in FIGS. 6 to 8 or FIGS. 9 and 10 described above.

At S110, UI content processing unit 220 determines whether or not a movie (video element) is included in the UI content. If it is determined that a movie (video element) is included in the UI content (YES at S110), the process proceeds to S120. Otherwise (NO at S110), the process proceeds to S210.

At S120, UI content processing unit 220 determines whether or not the continuous reproduction flag saved in continuous reproduction flag saving area 282 of storage unit 280 is “continuous reproduction on.” If the continuous reproduction flag is determined to be “continuous reproduction on,” condition A mentioned above is satisfied (YES at S120), and the process proceeds to S130. Otherwise (NO at S120), the process proceeds to S160.

At S130, UI content processing unit 220 determines whether or not the attribute value of xlink:href (URI of the movie) of video element in the received UI content includes “PlayPos=prolong” statement. If it is determined that “PlayPos=prolong” statement is included, condition B described above is satisfied (YES at S130), and the process proceeds to S140. Otherwise (NO at S130), the process proceeds to S160.

At S140, UI content processing unit 220 determines whether or not the movie URI as the attribute value of xlink:href of video element in the received UI content without “PlayPos=prolong” matches the URI saved in movie URI saving area 284 of storage unit 280. If the URIs are determined to match, condition C described above is satisfied (YES at S140), and the process proceeds to S150. Otherwise (NO at S140), the process proceeds to S160.

At S150, UI content processing unit 220 sends the movie to the buffer of control unit 210 so that the movie that has been reproduced is continuously displayed. Thereafter, the process proceeds to S190.

At S160, UI content processing unit 220 determines whether or not there is any movie that is being continuously reproduced. If it is determined that there is a movie that is being continuously reproduced (YES at S160), the process proceeds to S170. Otherwise (NO at S160), the process proceeds to S180.

At S170, UI content processing unit 220 stops the movie that is being reproduced. At S180, based on a movie URI represented by the attribute value of xlink:href of video element in the received UI content without “PlayPos=prolong,” UI content processing unit 220 acquires a new movie from movie providing apparatus 400 and reproduces the same. Thereafter, the process proceeds to S190.

At S190, UI content processing unit 220 determines whether or not a statement to turn on the continuous reproduction flag is included in the received UI content. Here, if “videoElem.setProperty(‘prolong’,1)” is defined in the script description section of UI content, it is determined that a statement to turn on the continuous reproduction flag (to change the state of continuous reproduction flag to “continuous reproduction on”) is included. If the statement to turn on the continuous reproduction flag is included (YES at S190), the process proceeds to S200. Otherwise (NO at S190), the process proceeds to S210.

At S200, UI content processing unit 220 saves the attribute value of xlink:href (URI) of video element having the ID information designated by this statement in movie URI saving area 284, turns on the current state of continuous reproduction flag to “continuous reproduction on,” and saves the flag in continuous reproduction flag saving area 282 of storage unit 280. Thereafter, the process proceeds to S220. At S210, UI content processing unit 220 turns off the current state of continuous reproduction flag to “continuous reproduction off,” and saves the flag in continuous reproduction flag saving area 282 of storage unit 280. The initial value of this flag is “continuous reproduction off” and, therefore, in the absence of the statement, the state of continuous reproduction flag is kept “continuous reproduction off” and the flag is saved in continuous reproduction flag saving area 282 of storage unit 280.

At S220, UI content processing unit 220 draws other drawing elements (still images including advertising information and menu information) (and transmits these to the buffer of control unit 210 if necessary).

At S230, UI content processing unit 220 determines whether or not the user instruction input from user input unit 260 is to make a transition to a next page or to end the display of SVG. If it is determined to be a transition to the next page or end of SVG display (YES at S230), the process proceeds to S240. Otherwise (NO at S230), the process returns to S230 and enters a loop for detecting an event.

At S240, UI content processing unit 220 determines whether or not the continuous reproduction flag saved in continuous reproduction flag saving area 282 of storage unit 280 is “continuous reproduction off” and whether or not there is any movie that is being reproduced. If the continuous reproduction flag is “continuous reproduction off” and there is a movie that is being reproduced (YES at S240), the process proceeds to S250. Otherwise (NO at S240), the process ends. At S250, UI content processing unit 220 ends reproduction of the movie. If the continuous reproduction flag is “continuous reproduction on,” the reproduction ending process of S250 is not executed and the movie that is being reproduced is continuously reproduced.

<Operation>

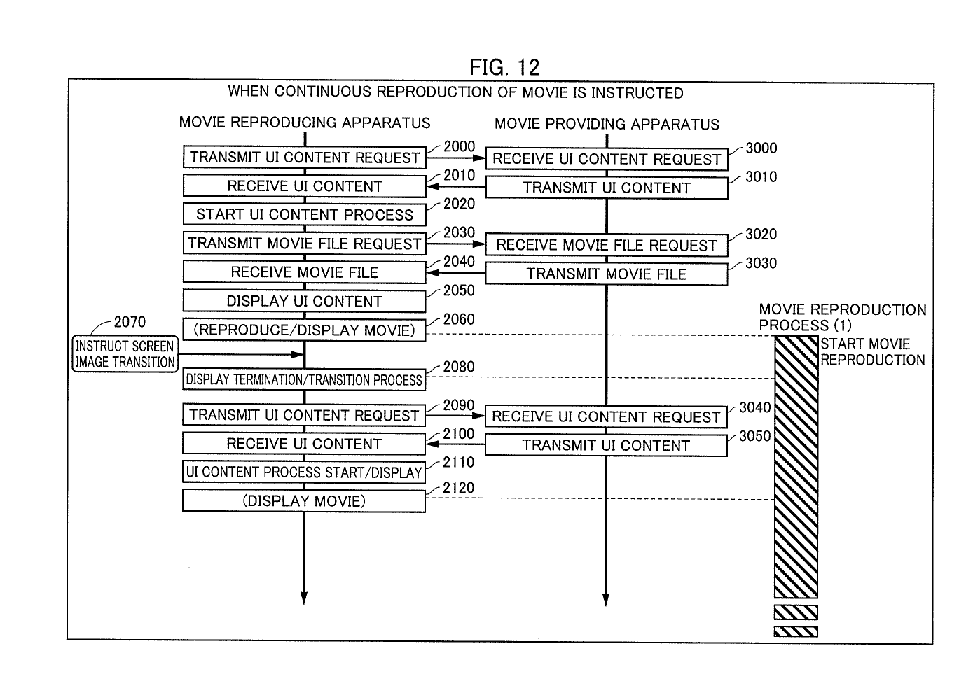

The operation of movie reproducing system in accordance with the present embodiment based on the structure and flowchart as described above will be described with reference to FIGS. 12 to 14. In the description of operation below, the same components will be denoted by the same reference characters. Their operations are also the same. Therefore, detailed description thereof will not be repeated.

[When Continuous Reproduction of Movie is Requested]

Referring to FIG. 12, a UI content request is transmitted from movie reproducing apparatus 200 to movie providing apparatus 400 (operation 2000), movie providing apparatus 400 receives the content request (operation 3000), and UI content is transmitted from movie providing apparatus 400 to movie reproducing apparatus 200 (operation 3010). Movie reproducing apparatus 200 receives the UI content from movie providing apparatus 400 (S100, operation 2010), and the UI content process (SVG display process) starts (operation 2020). It is assumed that the UI content here is demo1.svg shown in FIGS. 6 to 8. In demo1.svg, a statement to turn on the continuous reproduction flag is defined in movie continuous reproduction request statement 1312, as the continuation request information (videoElm.setProperty(‘prolong’,1)) (YES at S190). Therefore, the current state of continuous reproduction flag is turned on, to “continuous reproduction on” and saved in continuous reproduction flag saving area 282 of storage unit 280. Further, the attribute value of xlink:href (http://video-server.com/tvvideo.mpg) of video element having the ID information “tvvideo” designated by the statement above is saved in movie URI saving area 284 of storage unit 280 (S200).

Based on the movie URI in the layout description section (attribute value of xlink:href (http://video-server.com/tvvideo.mpg) of the video element) included in the UI content, a movie file request is transmitted from movie reproducing apparatus 200 to movie providing apparatus 400 (operation 2030), movie providing apparatus 400 receives the movie file request (operation 3020), and the movie file is transmitted from movie providing apparatus 400 to movie reproducing apparatus 200 (operation 3030).

After the movie file is received (operation 2040), UI content other than the movie is displayed (operation 2050), and reproduction and display of the movie start (operation 2060). Here, the screen image including the movie starts to be displayed on display unit 270 of movie reproducing apparatus 200 (movie reproduction process (1)).

If the movie is to be acquired through streaming technique, the acquiring process is continued after the transmission (operation 3030) and reception (operation 2040) of the movie.

When the user presses the “yellow button,” it is notified as an event to UI content processing unit 220. In demo1.svg, in transition request statement 1314, a process that UI content processing unit 220 receiving the event makes a transition to the next page (http://servername/demo2.svg) and terminates the process for displaying demo1.svg is defined (YES at S230). Since the continuous reproduction flag is on (NO at S240), the movie that has been reproduced is continuously reproduced (operation 2080). Here, images including the movie are continuously kept displayed on display unit 270 of movie reproducing apparatus 200 (movie reproduction process (1)).

A UI content request is transmitted from movie reproducing apparatus 200 to movie providing apparatus 400 (operation 2090), movie providing apparatus 400 receives the UI content request (operation 3040), and UI content is transmitted from movie providing apparatus 400 to movie reproducing apparatus 200 (operation 3050). Movie reproducing apparatus 200 receives the UI content from movie providing apparatus 400 (S100, operation 2100), and the UI content process (SVG display process) starts (operation 2110). It is assumed that the UI content here is demo2.svg shown in FIGS. 9 and 10.

In demo2.svg, a movie (video element) is included (YES at S110), the state of continuous reproduction flag saved in continuous reproduction flag saving area 282 of storage unit 280 is “continuous reproduction on” (YES at S120), the attribute value of xlink:href of the video element includes the statement “PlayPos=prolong” in movie designation 1436 of layout description section 1430 of demo2.svg (YES at S130), and the URI (http://video-server.com/tvvideo.mpg) saved in movie URI saving area 284 of storage unit 280 matches the URI defined in movie designation 1436 (YES at S140). Therefore, the movie that is being reproduced is continued (S150). Thus, as shown in FIG. 12, the same movie is continuously reproduced in operation 2120 also, as shown in FIG. 12. Specifically, on display unit 270, even if the screen image is switched from screen image 1100 of FIG. 3 to screen image 1200 of FIG. 4 (even if transition is made), the movie is reproduced continuously. Since the same movie is continuously reproduced, transmission of movie file to demo2.svg does not take place.

[When Continuous Reproduction of Movie is not Requested]

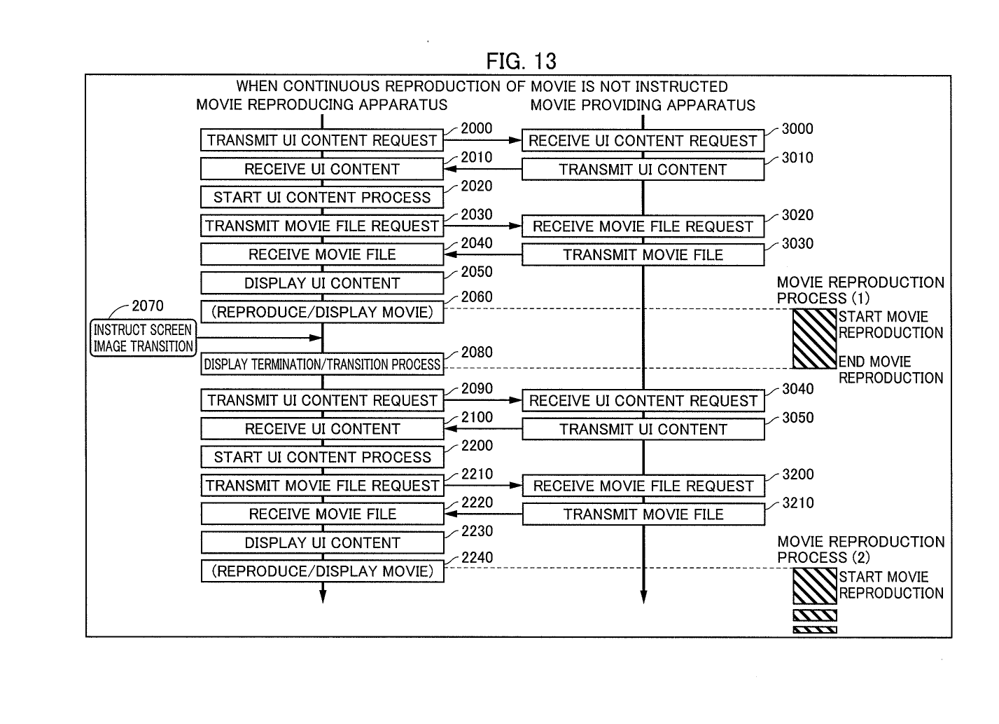

Referring to FIG. 13, when movie reproducing apparatus 200 receives the UI content from movie providing apparatus 400 (S100, S2010), UI content process (SVG display process) starts (operation 2020). It is assumed that the UI content here is demo11.svg. Different from demo1.svg, demo11.svg does not define the statement for turning on the continuous reproduction flag. Since the statement for turning on the continuous reproduction flag is not defined in demo11.svg (NO at S190), the current state of continuous reproduction flag is “continuous reproduction off,” which is saved in continuous reproduction flag saving area 282 of storage unit 280 (S210).

After a movie file request is transmitted from movie reproducing apparatus 200 to movie providing apparatus 400 (operation 2030), movie providing apparatus 400 receives the movie file request (operation 3020), and the movie file is transmitted from movie providing apparatus 400 to movie reproducing apparatus 200 (operation 3030).

UI content other than the movie is displayed (operation 2050), and reproduction and display of the movie start (operation 2060). Here, the screen image including the movie starts to be displayed on display unit 270 of movie reproducing apparatus 200 (movie reproduction process (1)).

When the user presses the “yellow button,” it is notified as an event to UI content processing unit 220. In demo11.svg, in transition request statement 1314, a process that UI content processing unit 220 receiving the event makes a transition to the next page (http://servername/demo2.svg) and terminates the process for displaying demo11.svg is defined (YES at S230). Since the continuous reproduction flag is off (YES at S240), reproduction of the movie is terminated (operation 2080). Here, as shown in FIG. 13, the movie that has been continuously reproduced is terminated (in response to operation 2080, movie reproduction process (1) ends).

When movie reproducing apparatus 200 receives the UI content from movie providing apparatus 400 (S100, operation 2100), the UI content process (SVG display process) starts (operation 2200).

In demo2.svg, a movie (video element) is included (YES at S110), the state of continuous reproduction flag saved in continuous reproduction flag saving area 282 of storage unit 280 is “continuous reproduction off” (NO at S120), and there is not a movie that is being continuously reproduced (NO at S160). Therefore, based on the URI defined in the movie designation in the layout description section of demo2.svg, a new movie is acquired and reproduced (S180, operations 2210 to 2240). As shown in FIG. 13, a new movie is reproduced, in response to operation 2240. Specifically, on display unit 270, after switching from screen image 1100 shown in FIG. 3, a movie, which is not the continuation, is reproduced (movie reproduction process (2)).

[When Continuous Reproduction of Movie is Requested: URI Mismatch]

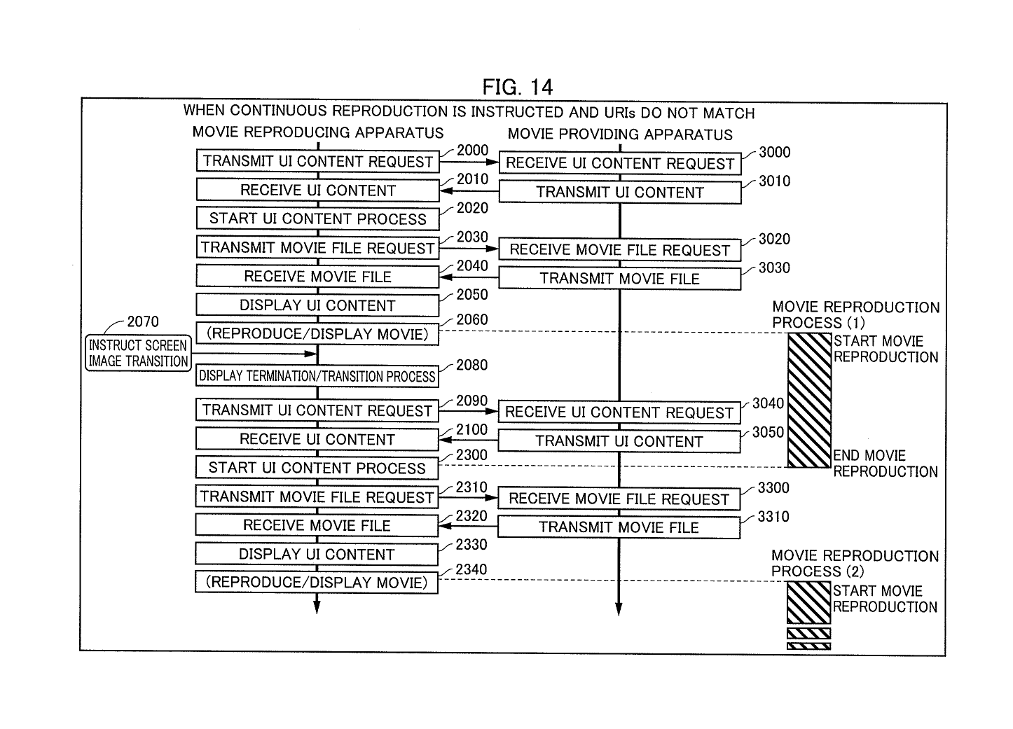

Referring to FIG. 14, when movie reproducing apparatus 200 receives UI content from movie providing apparatus 400 (S100, operation 2010), the UI content process (SVG display process) starts (operation 2020). It is assumed that the UI content here is demo12.svg. Different from demo1.svg, the URI of SVG file as the destination of next transition is not demo2.svg but demo22.svg (demo22.svg is the same as demo2.svg except that the movie URL is http://video-server.com/tvvideo2.mpg).

In demo12.svg, a statement to turn on the continuous reproduction flag (videoElem.setProperty(‘prolong’0.1)) is defined in movie continuous reproduction request statement 1312 (YES at S190). Therefore, the current state of continuous reproduction flag is turned on to “continuous reproduction on” and saved in continuous reproduction flag saving area 282 of storage unit 280. Further, the attribute value of xlink:href (http://video-server.com/tvvideo.mpg) of a video element having the ID information “tvvideo” designated by the statement mentioned above is saved in movie URI saving area 284 of storage unit 280 (S200).

After a movie file request is transmitted from movie reproducing apparatus 200 to movie providing apparatus 400 (operation 2030), movie providing apparatus 400 receives the movie file request (operation 3020), and the movie file is transmitted from movie providing apparatus 400 to movie reproducing apparatus 200 (operation 3030).

UI content other than the movie is displayed (operation 2050), and reproduction and display of the movie start (operation 2060). Here, the screen image including the movie starts to be displayed on display unit 270 of movie reproducing apparatus 200 (movie reproduction process (1)).

When the user presses the “yellow button,” it is notified as an event to UI content processing unit 220. In demo12.svg, in transition request statement 1314, a process that UI content processing unit 220 receiving the event makes a transition to the next page (http://servername/demo22.svg) and terminates the process for displaying demo12.svg is defined (YES at S230). Here, the continuous reproduction flag is on (NO at S240), and the movie that has been reproduced is kept continuously reproduced (operation 2080). Here, on display unit 270 of movie reproducing apparatus 200, images including the movie are continuously displayed (movie reproduction process (1)).

Movie reproducing apparatus 200 receives the UI content from movie providing apparatus 400 (S100, operation 2010), and the UI content process (SVG display process) starts (operation 2300). It is assumed that the UI content here is demo22.svg.

In demo22.svg, a movie (video element) is included (YES at S110), the state of continuous reproduction flag saved in continuous reproduction flag saving area 282 of storage unit 280 is “continuous reproduction on” (YES at S120), and the attribute value of xlink:href of the video element includes the statement “PlayPos=prolong” in movie designation 1436 of layout description section 1430 of demo2.svg (YES at S130). However, the URI (http://video-server.com/tvvideo.mpg) saved in movie URI saving area 284 does not match the URI (http://video-server.com/tvvideo2.mpg) defined in the movie designation (NO at S140). Therefore, as shown in FIG. 14, the movie that has been continuously reproduced is terminated (S170, movie reproduction process (1) ends in response to operation 2300).

Based on the URI (http://video-server.com/tvvideo2.mpg) defined in the movie designation in the layout description section of demo22.svg, a new movie is obtained and reproduced (S180, operations 2310 to 2340). Therefore, as shown in FIG. 14, a new movie is reproduced in response to operation 2340. Specifically, when the screen image is switched from screen image 1100 of FIG. 3, a new movie is reproduced (movie reproduction process (2)).

Here, though there is a request for continuously reproducing the movie, the URI of movie file defined in the SVG file as the destination of next transition does not much, and hence, continuous reproduction of the movie fails. Therefore, where there is a request for continuous reproduction of a movie in the process based on demo12.svg, continuous reproduction of a movie designated, for example, by an ill-intentioned third party rather than a movie designated by a well-intended person, can be prevented.

As described above, in accordance with the movie reproducing system in accordance with the present embodiment, while a movie is provided from the movie providing apparatus in response to a user's request and the movie is reproduced on the movie reproducing apparatus, even if the layout description is changed to improve degree of freedom in expressing the provided content, it is possible to continuously reproduce the movie file. Particularly, using text files in XML format using SVG, the movie is reproduced continuously if the following three conditions are all satisfied: (A) the continuous reproduction request flag is on; (B) it is the movie file of which continuous reproduction is requested; and (C) the movie files before and after the transition are identical. Therefore, the movie can be reproduced safely and continuously without significantly changing an existing browser.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

### INDUSTRIAL APPLICABILITY

The present invention is applicable to a movie reproducing system (digital television system) and the like in which movie information, layout information and link information are acquired through a network to reproduce a movie.

1. A movie reproducing apparatus, comprising:
acquiring means for acquiring data including movie specifying information specifying a movie to be reproduced and continuation request information representing a request for continuously reproducing the movie;
display means for displaying images including the movie;
user input receiving means for receiving a request for making a display transition input by a user;
storage means for storing identification information indicating that continuous reproduction of a movie before and after the transition is requested, based on data acquired before the transition request, and movie information specifying the movie of which continuous reproduction is requested; and
control means for continuously reproducing and displaying, when said identification information is stored, the movie specified by said movie specifying information, based on said movie information and data acquired after the transition request.

2. The movie reproducing apparatus according to claim 1, wherein
said control means includes
means for storing, if a continuation request information is included in the data acquired before the transition request, said identification information in said storage means and the movie specifying information included in the data acquired before the transition request as said movie information in said storage means; and
means for continuously reproducing and displaying the movie specified by said movie specifying information, if the data acquired after the transition request includes the continuation request information, said identification information is stored in said storage means, and the movie specifying information included in the data acquired after the transition request matches the movie information stored in said storage means.

3. The movie reproducing apparatus according to claim 1, wherein said data is described in scalable vector graphics language.

4. The movie reproducing apparatus according to claim 1, wherein said movie specifying information and said movie information are described in link format.

5. The movie reproducing apparatus according to claim 1, wherein
said data further includes layout information defining a manner of reproducing the movie on said display means; and
said display means includes means for displaying images including the movie, in accordance with said layout information.

6. The movie reproducing apparatus according to claim 1, wherein
said data further includes information defining a process when a request for making transition of said display is input; and
said control means includes means for displaying images including the movie after the transition request on said display means in accordance with said information.

7. The movie reproducing apparatus according to claim 1, wherein said control means includes means for reproducing, if a movie is not to be displayed continuously, the movie specified by the movie specifying information acquired after the transition request, from the start.

8. A movie reproducing method, comprising:
the acquiring step of acquiring data including movie specifying information for specifying a movie to be reproduced and continuation request information representing a request for continuously reproducing the movie;
the display step of displaying images including the movie;
the user input receiving step of receiving a request for making a display transition input by a user;
the storage step of storing identification information representing that continuous reproduction of a movie before and after the transition is requested, and movie information specifying the movie of which continuous reproduction is requested, based on the data acquired before the transition request; and
the control step of continuously reproducing and displaying, if said identification information is stored, the movie specified by said movie specifying information, based on the movie information and the data acquired after the transition request.

9. A recording medium recording a computer program causing a computer to function as a movie reproducing apparatus, wherein said computer programs causes, when executed by said computer, said computer to function as:
acquiring means for acquiring data including movie specifying information specifying a movie to be reproduced and continuation request information representing a request for continuously reproducing the movie;
display means for displaying images including the movie;
user input receiving means for receiving a request for making a display transition input by a user;
storage means for storing identification information indicating that continuous reproduction of a movie before and after the transition is requested, based on data acquired before the transition request, and movie information specifying the movie of which continuous reproduction is requested; and
control means for continuously reproducing and displaying, when said identification information is stored, the movie specified by said movie specifying information, based on said movie information and data acquired after the transition request.

10. The movie reproducing apparatus according to claim 2, wherein said data is described in scalable vector graphics language.

11. The movie reproducing apparatus according to claim 2, wherein said movie specifying information and said movie information are described in link format.

12. The movie reproducing apparatus according to claim 3, wherein said movie specifying information and said movie information are described in link format.

13. The movie reproducing apparatus according to claim 2, wherein
said data further includes layout information defining a manner of reproducing the movie on said display means; and
said display means includes means for displaying images including the movie, in accordance with said layout information.

14. The movie reproducing apparatus according to claim 3, wherein
said data further includes layout information defining a manner of reproducing the movie on said display means; and
said display means includes means for displaying images including the movie, in accordance with said layout information.

15. The movie reproducing apparatus according to claim 4, wherein
said data further includes layout information defining a manner of reproducing the movie on said display means; and
said display means includes means for displaying images including the movie, in accordance with said layout information.

16. The movie reproducing apparatus according to claim 2, wherein
said data further includes information defining a process when a request for making transition of said display is input; and
said control means includes means for displaying images including the movie after the transition request on said display means in accordance with said information.

17. The movie reproducing apparatus according to claim 3, wherein
said data further includes information defining a process when a request for making transition of said display is input; and
said control means includes means for displaying images including the movie after the transition request on said display means in accordance with said information.

18. The movie reproducing apparatus according to claim 4, wherein
said data further includes information defining a process when a request for making transition of said display is input; and
said control means includes means for displaying images including the movie after the transition request on said display means in accordance with said information.

19. The movie reproducing apparatus according to claim 2, wherein said control means includes means for reproducing, if a movie is not to be displayed continuously, the movie specified by the movie specifying information acquired after the transition request, from the start.

20. The movie reproducing apparatus according to claim 3, wherein said control means includes means for reproducing, if a movie is not to be displayed continuously, the movie specified by the movie specifying information acquired after the transition request, from the start.
